(19) United States
(12) Patent Application Publication
(10) Pub. No.: US 2021/0158308 A1
(43) Pub. Date: May 27, 2021

(54) METHOD AND SYSTEM FOR CONTAMINATION ASSESSMENT

(71) Applicant: Compology, Inc., San Francisco, CA (US)

(72) Inventors: Justin Armstrong, San Francisco, CA (US); Jordan Hamel, San Francisco, CA (US); Shandy Brown, San Francisco, CA (US); Eric Johnson, San Francisco, CA (US); Reza Kashani, San Francisco, CA (US); Jason Skylar Gates, San Francisco, CA (US); Benjamin Chehebar, San Francisco, CA (US)

(21) Appl. No.: 17/145,021

(22) Filed: Jan. 8, 2021

Related U.S. Application Data
(63) Continuation-in-part of application No. 16/570,936, filed on Sep. 13, 2019.
Application No. 16/570,936 is a continuation-in-part of application No. 16/288,593, filed on Feb. 28, 2019.
Application No. 16/288,593 is a continuation of application No. 14/479,136, filed on Sep. 5, 2014, now abandoned.
Application No. 14/479,136 is a continuation-in-part of application No. 14/211,709, filed on Mar. 14, 2014, now abandoned.
(60) Provisional application No. 61/801,021, filed on Mar. 15, 2013.
(60) Provisional application No. 62/731,249, filed on Sep. 14, 2018.
(60) Provisional application No. 62/795,957, filed on Jan. 23, 2019.

(51) Int. Cl. G06Q 10/00; H04N 7/18; G06T 7/00; G06Q 10/06

(52) U.S. Cl. CPC G06Q 10/30; H04N 7/181; G06T 7/0008; Y02W 90/00; G06T 2207/30232; G06T 2207/30242; G06Q 10/0631

(57) ABSTRACT

A method for contamination assessment, which can include receiving a set of images, sorting the images, assessing the images, assessing container fill zones, assessing the container, and/or acting based on the container assessment. A system for contamination assessment, which can include a computing system, one or more containers, and/or one or more content sensors.

### CROSS-REFERENCE TO RELATED APPLICATIONS

This application is a continuation-in-part of U.S. application Ser. No. 16/570,936 filed 7 Nov. 2019, which is a continuation-in-part of U.S. application Ser. No. 16/288,593 filed 28 Feb. 2019, which is a continuation of U.S. application Ser. No. 14/479,136 filed 5 Sep. 2014, which is a continuation-in-part of U.S. application Ser. No. 14/211,709 filed 14 Mar. 2014, which claims the benefit of U.S. Provisional Application No. 61/801,021, filed 15 Mar. 2013, and also which claims the benefit of U.S. Provisional Application Ser. No. 62/731,249, filed on 14 Sep. 2018, and U.S. Provisional Application Ser. No. 62/795,957, filed on 23 Jan. 2019, each of which is incorporated in its entirety by this reference.

### TECHNICAL FIELD

This invention relates generally to the container management field, and more specifically to a new and useful method and system for contamination assessment in the container management field.

### BACKGROUND

Typical methods and systems for container contamination assessment require contents sorting, manual intervention, and/or complex monitoring equipment. Thus, there is a need in the container management field to create a new and useful method and system for contamination assessment.

### BRIEF DESCRIPTION OF THE FIGURES

FIG. 1 is a schematic representation of an embodiment of the method.

FIG. 2 is a schematic representation of an embodiment of the system.

FIGS. 3A-3C are schematic representations of various examples of one or more content sensors coupled to a container.

FIGS. 4A-4E are various examples of container images.

FIG. 5 is a schematic representation of an embodiment of assessing container fill zones.

FIG. 6 is a schematic representation of a specific example of assessing container fill zones.

FIGS. 7A-7B are schematic representations of a first and second example, respectively, of an image classifier associated with contaminant detection.

FIG. 8 is a schematic representation of an example of a pre-training network.

FIG. 9A is a schematic representation of an embodiment of training an image classifier.

FIG. 9B is a schematic representation of an example of performing pre-training.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

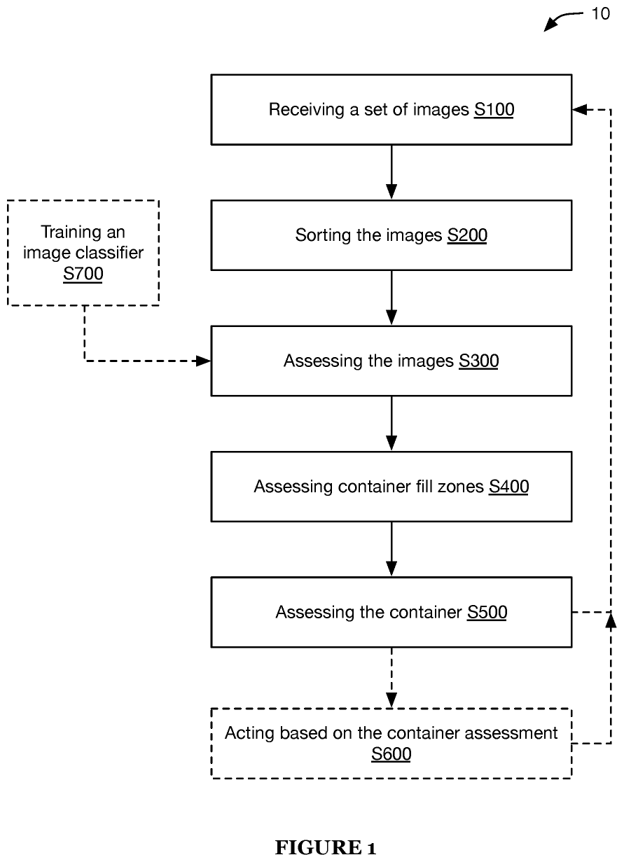

A method 10 for contamination assessment preferably includes: receiving a set of images S100, sorting the images S200, assessing the images S300, assessing container fill zones S400, and/or assessing the container S500, and can optionally include acting based on the container assessment S600 and/or training an image classifier S700 (e.g., as shown in FIG. 1). However the method 10 can additionally or alternatively include any other suitable elements.

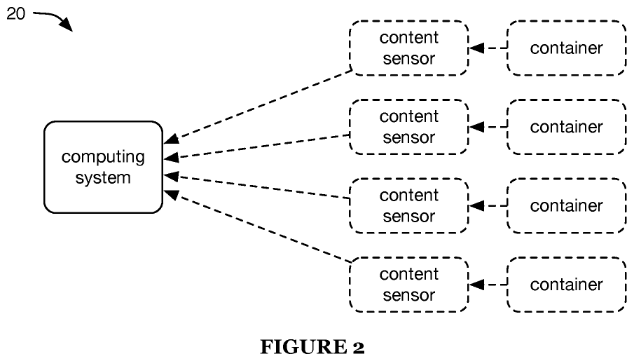

A system 20 for contamination assessment preferably includes a computing system (e.g., remote server), and can additionally or alternatively include one or more containers, one or more content sensors (e.g., imaging devices) associated with each container, and/or any other suitable elements (e.g., as shown in FIG. 2).

The method 10 is preferably performed using the system 20, but can additionally or alternatively be performed by any other suitable system.

### 2. System.

The containers can include dumpsters (e.g., front load containers, roll off containers, etc.), shipping containers (e.g., intermodal freight containers, unit load devices, etc.), sections of a vehicle (e.g., land, sea, air, and/or space vehicle) such as vehicle cargo holds or trailers, rooms of a structure (e.g., a fixed structure such as a building), and/or any other suitable containers.

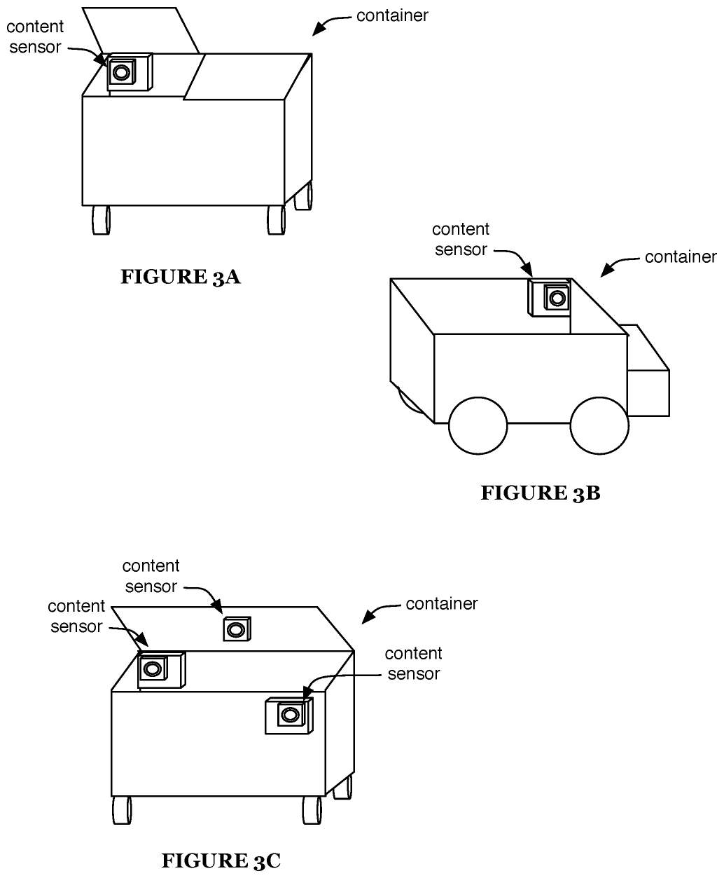

The content sensor is preferably configured to sense (e.g., image) the interior of the container that it is associated with (e.g., image and/or otherwise sense the contents of the container), more preferably configured to sense substantially all of the interior but alternatively configured to image any suitable portion thereof. The content sensor preferably has a fixed position and/or orientation relative to the container (e.g., is mechanically coupled to the container, preferably by a fixed coupling) but can alternatively have any other suitable spatial relationship with respect to the container (e.g., as shown in FIGS. 3A-3C).

The content sensor preferably includes one or more imaging devices. The imaging device is preferably an optical sensor (e.g., camera), but can additionally or alternatively include an ultrasound imaging device and/or any other suitable imaging devices. Examples of optical sensors include a monocular camera, stereocamera, multi-lens or multi-view camera, color camera (e.g., an RGB camera) such as a charge coupled device (CCD) or a camera including a CMOS sensor, grayscale camera, multispectral camera (narrow band or wide band), hyperspectral camera, ultraspectral camera, spectral camera, spectrometer, time of flight camera, high-, standard-, or low-dynamic range cameras, range imaging system (e.g., LIDAR system), active light system (e.g., wherein a light, such as an IR LED, is pulsed and directed at the subject and the reflectance difference measured by a sensor, such as an IR sensor), thermal sensor, infra-red imaging sensor, projected light system, full spectrum sensor, high dynamic range sensor, or any other suitable imaging system. The optical sensor is preferably configured to capture a 2-dimensional or 3-dimensional image, but can alternatively capture any a measurement having any other suitable dimension. The image is preferably single, multi-pixel, time-averaged or sum total measurement of the intensity of a signal emitted or reflected by objects within a field of view, but can alternatively be a video (e.g., a set of images or frames), or any other suitable measurement. The image preferably has a resolution (e.g., cycles per millimeter, line pairs per millimeter, lines of resolution, contrast vs. cycles/mm, modulus of the OTF, or any other suitable measure) capable of resolving a 1 cm³ object at a sensor distance of at least 10 feet from the object, but can alternatively have a higher or lower resolution.

The content sensor can optionally include one or more emitters that are configured to emit electromagnetic signals, audio signals, compounds, or any other suitable interrogator that the content sensor is configured to measure. However, the content sensor can additionally or alternatively measure signals from the ambient environment. Examples of sensor-emitter pairs include LIDAR systems, time-of-flight systems, ultrasound systems, radar systems, X-ray systems, and/or any other suitable systems. In embodiments in which the content sensor includes an emitter, the content sensor can optionally include a reference sensor that measures the ambient environment signals (e.g., wherein the content sensor measurement can be corrected by the reference sensor measurement).

The content sensor can optionally include a lens that functions to adjust the optical properties of the incident signal on the sensor. For example, the optical sensor can include a fish-eye lens to broaden the area monitored by the optical sensor, wherein the resultant distortion is known and can be adjusted for during image processing. However, the lens can be a wavelength filter, polarizing filter, or any other suitable lens. The content sensor can additionally or alternatively include a physical or digital filter, such as a noise filter that corrects for interferences in the measurement.

The content sensors can optionally include one or more communication modules. The communication module preferably functions to communicate data from the content sensor to a second system (e.g., the computing system). The data can be measurements from the content sensor (and/or any other suitable components), processed measurements, instructions, pickup requests, and/or any other suitable data.

The second system (e.g., computing system) can be a device (e.g., electronic user device), server system, or any other suitable computing system. The second system can be remote or wired to the communication system. Examples of the second system include a mobile device (e.g., smartphone, tablet, computer), server system, or any other suitable computing system. The communication system can be a wireless or wired communication system. The communication system can be a cellular, WiFi, Zigbee, Z-Wave, near-field communication system (e.g., Bluetooth, RF, NFC, etc.), Ethernet, powerline communication, or any other suitable communication system. The communication system is preferably operable in a standby or off mode, wherein the communication system consumes power at a rate less than a threshold rate, and an on or communication mode, wherein the communication system consumes power at a rate required to communicate data. However, the communication system can be operable in any other suitable mode.

The computing system preferably functions to process the images sampled by the content sensor. The computing system can perform all or a portion of the method described below. The computing system can include: a remote computing system (e.g., server system), a processing system on-board the content sensor (e.g., microprocessor, CPU, GPU, etc.), a user device (e.g., a smartphone), and/or any other suitable computing system.

The content sensor can optionally include one or more auxiliary sensors, such as IMU sensors (e.g., accelerometer, gyroscope, magnetometer, etc.), geopositioning elements (e.g., GPS receiver), weight sensors, audio sensors, and/or any other suitable auxiliary sensors. However, the imaging devices can additionally or alternatively include any other suitable elements in any suitable arrangement.

### 3. Method.

### 3.1 Receiving a Set of Images.

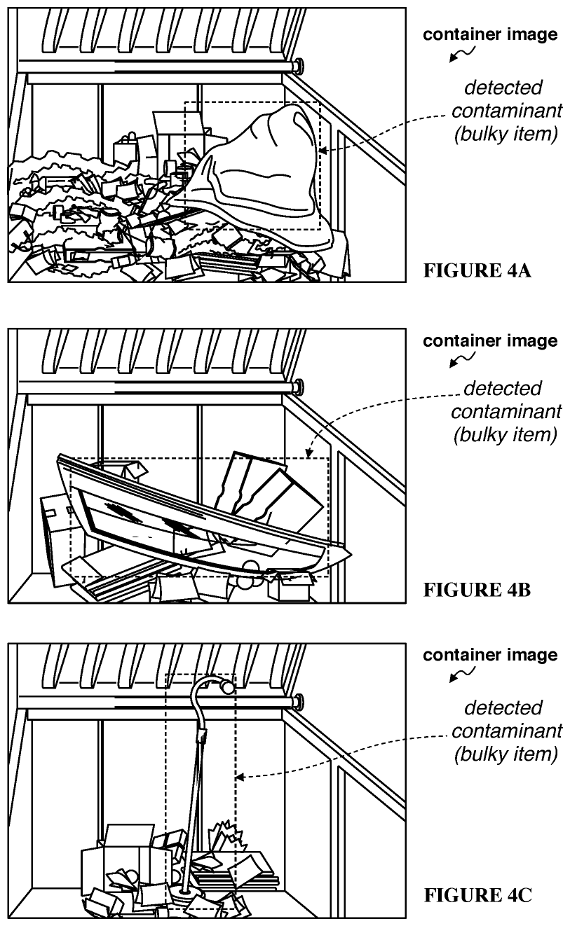

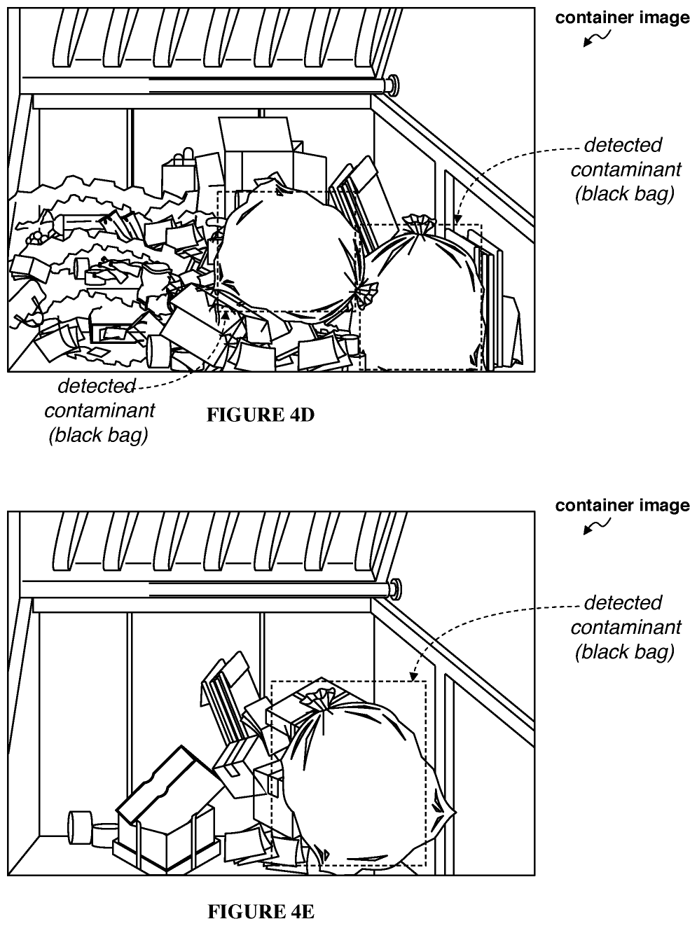

Receiving a set of images S100 preferably functions to provide data associated with the contents of the container (e.g., data indicative of the contents). Each image of the set is preferably a photograph (e.g., as shown in FIGS. 4A-4E) or a group of photographs, such as photographs from multiple cameras (e.g., captured within a threshold time interval of each other, such as captured substantially concurrently), but can additionally or alternatively include any other suitable sensor information (e.g., spatial sensor information such as from an ultrasound sensor).

The set of images can optionally include auxiliary data (e.g., associated with each image of the set, associated with the entire set, etc.). The auxiliary data can include, for example, image capture time, container fill level, auxiliary sensor information (e.g., container weight, container state, ultrasound sensor information, etc.) and/or any other suitable information. The auxiliary data is preferably captured within a threshold time interval (e.g., 1, 3, 10, 30, 60, 150, 300, 600, 1200, 0.1-1, 1-10, 10-100, 100-1000, or 1000-10,000 s; 1, 3, 10, 30, 60, 120, 300, 600, 1200, 2400, 4800, 10,000, 0.1-1, 1-10, 10-100, 100-1000, 1000-10,000, or 10,000-100,000 min; etc.) around the capture time of the associated image (e.g., substantially concurrent with image capture) but can additionally or alternatively be associated with any other suitable time(s).

The set of images is preferably associated with (e.g., representative of, depicting, etc.) a single container, more preferably having the same view (e.g., captured by the same camera in the same orientation) in each image. However, images of the set can alternatively be from multiple views, multiple containers, and/or any other suitable sources. The set of images are preferably associated with a single haul (e.g., captured during the time interval bounded by two consecutive service events, such as a container unload event and/or a container relocation event, for the container with which they are associated), but can alternatively include images from multiple hauls (e.g., consecutive hauls, non-contiguous hauls, etc.) and/or any other suitable time intervals.

The set of images can optionally include or exclude substantially duplicative images, such as wherein the images and/or imaged content are substantially equivalent (e.g., for a group of consecutively captured images). Additionally or alternatively, S100 can include removing substantially duplicative images (e.g., removing all but one of each group of substantially duplicative images). However, S100 can additionally or alternatively include receiving any other suitable set of images in any suitable manner.

### 3.2 Sorting the Images.

Sorting the images S200 preferably functions to determine an order of the images based on fill level. S200 preferably includes determining (e.g., quantifying) the container fill level, more preferably for each image of the set received in S100. The fill level can be determined based on the image, the auxiliary data, and/or any other suitable information. In a first embodiment, the fill level is determined computationally, such as using one or more machine learning techniques, computer vision techniques, and/or other statistical classifier-based techniques (e.g., using a neural network, such as a convolutional neural network, trained to determine container fill level). For example, the fill level can be determined such as described in U.S. patent application Ser. No. 16/709,127, filed 10 Dec. 2019 and titled “Method and System for Fill Level Determination”, which is herein incorporated in its entirety by this reference (e.g., as described in U.S. patent application Ser. No. 16/709,127 regarding the ‘method 10’, such as using a model trained such as described therein regarding S200 and reference images selected such as described therein regarding S300). In a second embodiment, the fill level is determined by a human (e.g., based on the image data). In a third embodiment, the fill level is provided as auxiliary data. In alternative embodiments, the container fill level is not quantified (for some or all images); for example, the images can be sorted based on fill level by using binary comparisons between pairs of images (e.g., for each pair compared, determining which image of the pair has a higher fill level, such as using a neural network trained to compare such images). However, the fill level can additionally or alternatively be determined in any other suitable manner.

In other embodiments, S200 can include sorting the images based on capture time (e.g., sorted chronologically) and/or any other suitable criteria. However, S200 can additionally or alternatively include sorting the images in any other suitable manner. Alternatively, the method can exclude image sorting (e.g., can include not performing S200), such as wherein the S500 includes assessing the container based only on a single image (e.g., the image with the highest contamination metric).

### 3.3 Assessing the Images.

Assessing the images S300 preferably functions to determine (e.g., quantify) the contamination observable in each image of the set. Contamination is preferably quantified based on the number of contaminant items, but can additionally or alternatively be quantified based on a contamination percentage (e.g., by weight, by volume, etc.) and/or any other suitable contamination metric. The contamination estimate is preferably conservative (e.g., including only a low rate of false positives, tending to underestimate the extent of contamination, etc.), which can function to reduce instances in which customers are incorrectly penalized for contaminants that are not actually present. However, the contamination can additionally or alternatively be quantified in any other suitable manner.

The contamination is preferably determined based on the image, but can additionally or alternatively be determined based on the auxiliary data and/or any other suitable information. In a first embodiment, the contamination is determined using one or more statistical classification, machine learning, and/or computer vision techniques (e.g., using a neural network, such as a deep neural network and/or convolutional neural network (CNN), trained to detect contaminants), preferably using one or more image classifiers trained such as described below regarding S700, but additionally or alternatively using any other suitable tools. In a second embodiment, the contamination is determined by a human (e.g., based on image). However, the contamination can additionally or alternatively be determined in any other suitable manner.

In one example of the first embodiment, the image can be provided as input to one or more CNNs (e.g., as a 3-channel RGB image, single channel greyscale image, etc.), wherein each CNN is trained to detect the presence of one or more types of contaminants in the image (e.g., wherein each CNN is trained to detect a different contaminant type, wherein a single CNN is responsible for detecting any contaminants, etc.). The CNN (or CNNs) preferably includes one or more: convolutional layers, pooling layers (e.g., max pooling layers), activation layers (e.g., rectified linear units), fully-connected layers, and/or any other suitable layers. The neural network preferably provides multiple output values, each corresponding to a different number of contaminant items (e.g., first output corresponding to 0 contaminant items, second output corresponding to 1 contaminant item, third output corresponding to 2 contaminant items, etc.). Preferably, each output represents a likelihood of and/or confidence in the corresponding contaminant count (e.g., the output values sum to 1). For example, the outputs can be the outputs of a softmax classifier. Alternatively, the output values can be arbitrary, such as output values of an SVM classifier and/or any other suitable classifier. Alternatively, the neural network can have one or more regression outputs (e.g., wherein the output value represents the contaminant count). In a specific example, the CNN includes multilabel classification layers, such as a plurality (e.g., array) of output layers (e.g., multiple softmax output layers, multiple independent logistic classifiers, etc.), each associated with a different contaminant type.

In some variations, the neural network is (or includes) a region proposal classification network (RPCN). In a first variation, the RPCN determines a set of regions of interest (e.g., bounding boxes) within an image, and then performs object classification of the content of each region of the set. In a second variation, the RPCN implements a “single look” approach (e.g., as described in Redmon, Joseph, and Ali Farhadi. “YOLOv₃: An incremental improvement.” arXiv:1804.02767v1 (2018), which is herein incorporated in its entirety by this reference). For example, in this variation, such a network can: determine regions of interest (e.g., with associated “objectness” scores indicative of the probability that the region of interest appropriately bounds an object of interest); classify content of sectors (e.g., grid squares) of the image (e.g., wherein a sector depicting a portion of a plastic bag is preferably classified into the plastic bag class), optionally wherein this classification is performed independent from the region of interest determination; and determine a set of classified regions based on both the determined regions of interest and the sector content classifications.

The network can include alternating convolutional (CONV) layers and pooling (POOL) layers (and/or alternating groups of one or more CONV with POOL layers), optionally with one or more activation layers (e.g., rectified linear unit (ReLU) layers) and/or normalization layers (e.g., batch normalization (BN) layers) in between some or all such alternating layers (e.g., wherein a BN and/or ReLU layer is optionally included after a CONV layer, such as wherein the BN layer is inserted after the CONV layer and before the ReLU layer). In some examples, the network includes one or more skip connections (e.g., a connection that concatenates and/or sums the output of an earlier (upstream) layer with that of a later (downstream) layer), residual blocks (e.g., blocks of CONV/POOL layers, optionally also including activation layers, which include some summing skip connections to nearby downstream layers such as other CONV layers of the block), and/or upsampling layers. The network can additionally or alternatively include one or more fully-connected layers (and/or otherwise densely-connected layers), final layers (e.g., softmax layers, other classifier layers such as linear and/or logistic classifier layers, etc.), and/or other layers (e.g., defining one or more detection sub-networks (DSNs)).

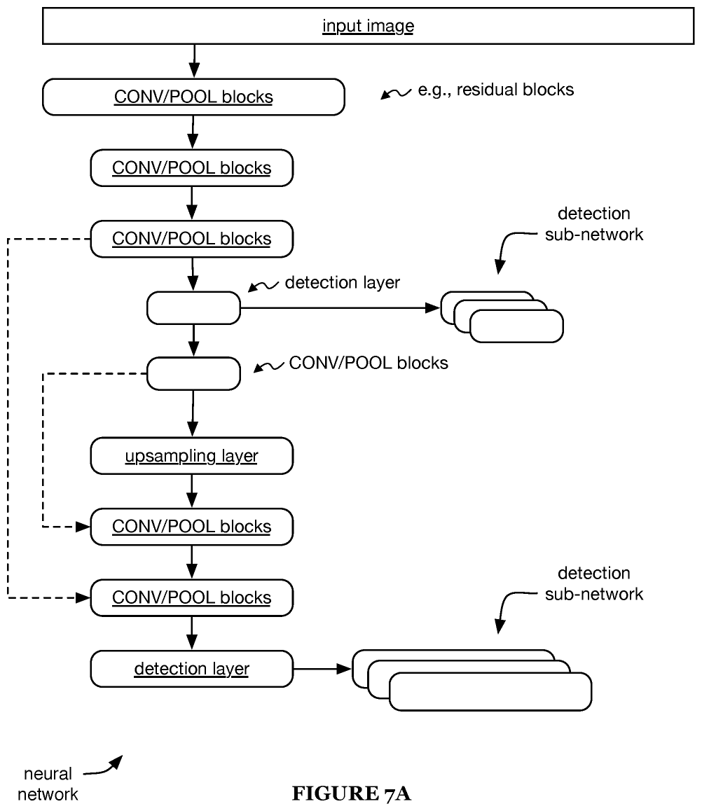

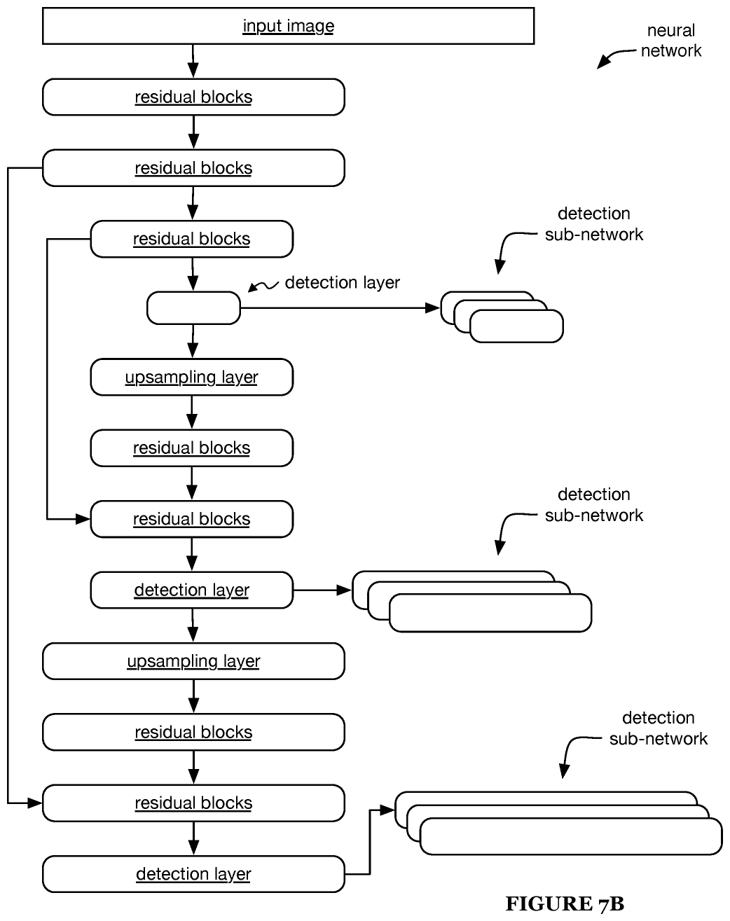

In one example, the network include detection elements at multiple scales. For example, one or more DSNs (e.g., each including a 1×1 detection kernel) can be applied to different-sized outputs from different locations in the network. In a specific example, the network can include (as a subset of the overall network, such as a network including many alternating CONV and POOL layers) downsampling (e.g., at a POOL layer), outputting at the downsampled scale to a first DSN, upsampling, and outputting at the upsampled scale to a second DSN. Preferably, in this specific example, the network further includes one or more skip connections that bridge (e.g., via concatenation) from a layer prior to the downsampling to a layer following the upsampling, such as wherein the skip connection bridges between layers of equal scale (e.g., as shown by way of examples in FIGS. 7A-7B). In some variations, the network includes multiple nested iterations of this concept (e.g., including, in order: multiple downsamplings, outputting to a first DSN, upsampling, outputting to a second DSN, upsampling, and outputting to a third DSN; preferably including a high-level skip connection that bridges from before the first downsampling to after the second upsampling, and a low-level skip connection that bridges from before the first DSN to after the first upsampling), such as wherein the network defines a U-shaped architecture.

However, the method can additionally or alternatively include using any other suitable neural network(s) to determine the contamination of the image, and/or using no such networks.

The contaminants can include specific items, such as bags of one or more particular compositions and/or colors (e.g., black bags, clear bags, plastic bags, etc.), bulky items (e.g., items exceeding one or more threshold dimensional constraints; item types such as pallets, furniture, tires, etc.; items in bulky configurations, such as uncollapsed cardboard boxes and/or other boxes; etc.), styrofoam, wood (e.g., tree branches, construction scraps, etc.), hazardous contaminants (e.g., pressurized vessels, propane tanks, etc.), electronic waste (e.g., televisions, displays, speakers, computers, portable electronics, etc.), items prone to tangling (e.g., garden hoses, light strings such as Christmas lights, packing straps, etc.), concrete, soil, and/or any other suitable specific contaminant items. Although described herein as contaminants, a person of skill in the art will recognize that the method and/or system can additionally or alternatively include characterizing any other suitable contents and/or content types, such as metal content types (e.g., metal form factors such as turnings, piping, stamping, mixed materials, etc.; metal compositions, such as steel, brass, etc.), material types (e.g., metal, rigid plastic, flexible plastic, organic, etc.), and/or any other suitable content characteristics.

In one embodiment of this variation, each neural network and/or subset (e.g., layer, output, subset of nodes, such as connected nodes defining a column or subtree, etc.) thereof can be trained to detect a different contaminant. The contaminants can additionally or alternatively include non-conforming items (e.g., items that do not conform to rules associated with the container, such as determined based on detecting all visible items that do conform to such rules). In one embodiment of this variation, the neural network can be trained to detect only the conforming items, and classify or label items as “contaminants” when an item that is not a conforming item is detected in the image. For example, in a compost bin, the non-conforming items can include any non-compostable items, whereas in a recycling bin, the non-conforming items can include any non-recyclable items.

Additionally or alternatively, some contaminant types (e.g., more common contaminants, such as plastic bags, uncollapsed cardboard boxes, etc.) may be detected specifically (e.g., wherein the classifier classifies an object specifically as a plastic bag or an uncollapsed cardboard box), whereas other contaminant types (e.g., less common contaminants, such as styrofoam, items prone to tangling, bulky items, construction debris, yard debris, electronic waste, etc.) may be grouped together into an “anomalous object” class (e.g., wherein the classifier classifies an object as anomalous, but not as any specific contaminant class). Optionally, some or all such objects (e.g., those classified as anomalous) maybe passed to one or more additional classification resources (e.g., human classifiers) for contaminant confirmation, further classification, and/or other processing.

However, S300 can additionally or alternatively include assessing the images in any other suitable manner.

Assessing the images S300 can optionally include classifying the images as “contaminated” or “clean” (uncontaminated), but can include classifying the image with any other suitable classifier (e.g. classifying the image with the specific contaminant). In variants, the “clean” images can be discarded or retained for training purposes. The contaminant detector can: classify the image as “contaminated” upon detecting the presence of contaminants (e.g., determining that one or more non-conforming items appear in the image); determine a contaminant count by counting the number of non-conforming items and/or known contaminants in each image (e.g., wherein layers of a neural network, such as each layer in an array of output layers, such as softmax output layers, can be specific to a given contaminant), optionally classifying the images as “contaminated” when the number exceeds 0; and/or otherwise classify the images as “contaminated” or “clean.” However, S300 can optionally include labeling the images with the specific contaminant (e.g., based on the elements of the output layers specific to the given contaminant), and/or any other suitable process.

The method can optionally include classifying the image (or set thereof) as “unknown.” Images can be classified as “unknown” when: the classification confidence level falls below a predetermined threshold, when the images cannot be classified as “clean” (“uncontaminated”) or “contaminated”, and/or otherwise classified as “unknown.” In one variation, images classified as “unknown” are sent for manual review (e.g., by a user), wherein the user reviews and labels the image with a “contaminated” or “clean” label (e.g., preferably identifying each contaminant item in the image, such as by selecting the image region corresponding to the contaminant item, labeling the contaminant item based on the contaminant type, and/or providing a contaminant count associated with the image). In a second variation, the “unknown” images can be sent to auxiliary detectors (e.g., with lower classification errors, different kappa coefficients, higher precision, higher recall, etc.), wherein the auxiliary detectors label the “unknown” images with the contamination status (e.g., “contaminated,” “clean”), contamination assessment (e.g., contaminant count), and/or the contaminant type(s). The labeled images can subsequently be used as training data to update the contamination detection system (e.g., train or update the neural network).

### 3.4 Assessing Container Fill Zones.

Assessing container fill zones S400 preferably functions to determine (e.g., quantify) contamination in each fill zone of the container, wherein a fill zone is preferably defined as a particular contiguous range of fill levels within the container (e.g., a first fill zone from 0% to 20% full, a second fill zone from 20% to 45% full, a third fill zone from 45% to 85% full, etc.). S400 preferably includes determining the fill zones (e.g., determining how many fill zones are associated with the set of images, determining which fill levels are associated with each fill zone, etc.), but can additionally or alternatively include using one or more predetermined fill zones.

For each fill zone, S400 preferably includes assessing the zone based on one or more rules. In a first embodiment, the zone is assessed based on the image of the zone (the “representative image”) indicative of the most contamination (e.g., the maximum number of contaminants depicted in a single image associated with the fill zone).

In a second embodiment, the zone is assessed based on multiple images, which can function to account for contaminants not observable in the representative image. In this embodiment, S400 preferably includes discriminating between different objects observed in different images, which can function to avoid double counting of the same object depicted in multiple images (e.g., thereby avoiding erroneously-high contamination assessments). In this embodiment, the object discrimination can be performed based on contaminant characteristics (e.g., size, shape, color, etc.), object position (e.g., within the image frame, within the container, etc.), and/or any other suitable information. For example, if a fill zone includes two images, each of which depict one contaminant item, S400 can include determining (e.g., based on the information type(s) described above) that the images depict two different contaminant items (e.g., less than a threshold probability of depicting the same contaminant item, such as a probability less than 30%, 20%, 10%, 5%, 2%, 1%, 0-1%, 1-3%, 3-10%, 10-30%, 30-50%, etc.), and thus determining that the fill zone contains two contaminant items (one depicted in the first image, and the other depicted in the second image); or alternatively, can include determining that the images may depict the same contaminant item (e.g., more than a threshold probability of depicting the same contaminant item, such as a probability greater than 5%, 10%, 20%, 30%, 50%, 75%, 90%, 2-5%, 5-15%, 15-35%, 35-60%, 60-80%, or 80-100%, etc.), and thus determining that the fill zone contains one contaminant item. However, the fill zone can additionally or alternatively be assessed using any other suitable rules.

S400 can optionally include saving the representative image (and/or any other suitable images, such as other images used to assess the fill zone, images depicting detected contaminants not visible in the representative image, etc.). For example, the saved images can be presented and/or made available to users (e.g., customers, regulatory partners, etc.) to offer direct evidence of the detected contamination. However, the images can additionally or alternatively be saved and/or presented in any other suitable manner.

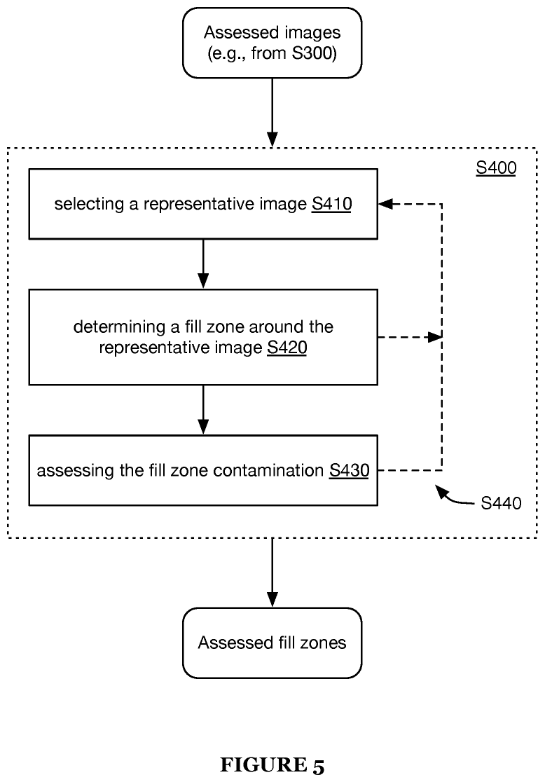

In some embodiments, S400 includes determining the fill zones and determining a contaminant count for each determined fill zone. Such embodiments can include, for example: selecting a representative image S400, determining a fill zone around the representative image S420, assessing the fill zone contamination S430, and/or repeating fill zone assessment S440 (e.g., as shown in FIG. 5).

Selecting a representative image S410 preferably functions to determine an image representative of contamination within a fill zone or potential fill zone. The representative image is preferably selected from images not yet assigned to a fill zone (e.g., images associated with fill levels that are not within one of the fill zones that have been determined at the time when S410 is performed). The representative image is preferably the image with the most contamination (e.g., largest number of contaminants), such as the most of all images not yet assigned to a fill zone. If multiple images are tied or substantially tied, such as having contamination metrics within a threshold absolute amount (e.g., 1, 2, 3-5, 5-10, or more than 10 items, etc.) or relative amount (e.g., 1%, 2%, 5%, 10%, 15%, 20%, 25%, 30%, 0-3%, 3-10%, 10-30%, 30-50%, etc.) of each other, the tie is preferably broken based on which image is closest to the middle of a fill range associated with the images, such as the fill range spanned by the tied images or the unassigned fill range. However, the tie can additionally or alternatively be broken based on image quality (e.g., preferably choosing a higher-quality image), uncertainty associated with fill level and/or contamination metric determination (e.g., preferably choosing an image for which the fill level and/or contamination metric uncertainty is low), and/or any other suitable criteria (or combinations thereof).

In a first example, the set of images depicts fill levels between 0% and 80%, and no fill zones have yet been determined. In this example, images with fill levels of 10%, 35%, and 50% all depict the same number contaminant items, which is greater than the number of contaminant items depicted in any other images of the set. In this example, the image with the 35% fill level is selected as the representative image (e.g., because 35% is closer to the middle of the 10-50% tied image range than both 10% and 50%, because 35% is closer to the middle of the 0-80% unassigned range than both 10% and 50%, etc.).

In a second example, the set of images depicts fill levels between 0% and 90%, and the fill levels in the range 40-80% have already been assigned to one or more fill zones. In this example, images with fill levels of 15%, 20%, and 35% all depict the same number contaminant items, which is greater than the number of contaminant items depicted in any other images of the set that have not already been assigned to a fill zone (e.g., are not in the 40-80% fill level range). In this example, the image with the 20% fill level is selected as the representative image (e.g., because 20% is closer to the middle of the 15-35% tied image range than both 15% and 35%, because 20% is the exact middle of the 0-40% range and so is closer to the middle of the 0-40% range than both 15% and 35%, etc.).

However, S410 can additionally or alternatively include selecting any other suitable representative image in any suitable manner.

Determining a fill zone around the representative image S420 preferably includes selecting a contiguous range of fill levels. The selected range is preferably within a threshold radius (in fill level space) of the representative image's fill level. The threshold radius is preferably a constant (e.g., predetermined) radius (e.g., 5, 10, 15, 20, 25, 30, 50, 0-3, 3-10, 10-30, 15-25, 5-35, or 30-50%, etc.), but can alternatively be a dynamically-determined radius (e.g., determined based on the rate of change of imaged contents with respect to time and/or fill level, based on the uncertainty in fill level determination and/or imaged contaminant detection, etc.) and/or any other suitable radius.

The selected range is preferably truncated at the boundary of previously-determined fill zones (e.g., the fill zone currently being determined does not overlap any previously determined fill zones). For example, the low end of the selected range can be equal (or substantially equal) to the greater of the value dictated based on the threshold radius (the representative image's fill level minus the threshold radius) or the greatest high end of a previously-determined fill range that lies below the representative image's fill level. Analogously, the high end of the selected range can be equal (or substantially equal) to the lesser of the value dictated based on the threshold radius (the representative image's fill level plus the threshold radius) or the lowest low end of a previously-determined fill range that lies above the representative image's fill level. However, the selected range can additionally or alternatively overlap previously-determined zones (e.g., at higher fill values only, at lower fill values only, on both ends, etc.).

S420 preferably includes assigning all images (e.g., unassigned images) within the selected range to the fill zone (e.g., associating those images with the fill zone). However, S420 can additionally or alternatively include determining any other suitable fill zone in any suitable manner.

Assessing fill zone contamination S430 is preferably performed using a rule (e.g., as described above). S430 is preferably performed based on the representative image (and/or any other suitable images of the zone, images of other zones, etc.) However, S430 can additionally or alternatively include assessing fill zone contamination in any other suitable manner.

Repeating fill zone assessment S440 preferably includes repeating S400 (or a subset thereof, such as one or more of S410, S420, and/or S430). When repeating S400, the determined fill zones (and associated images) are preferably excluded from consideration. S440 is preferably performed until all fill levels represented by the received set (e.g., the entire range of fill zones represented, from the minimum fill zone represented by the set of images to the maximum fill zone represented by the set of images) are assigned to a fill zone (and until the contamination of all fill zones is assessed). If multiple (noncontiguous) unassigned fill ranges remain, S400 is preferably repeated separately for each such unassigned fill range. For example, if only the range between 45 and 85% fill has been assigned, S400 is preferably performed separately for the range between 0 and 45% and the range between 85% and 100%.

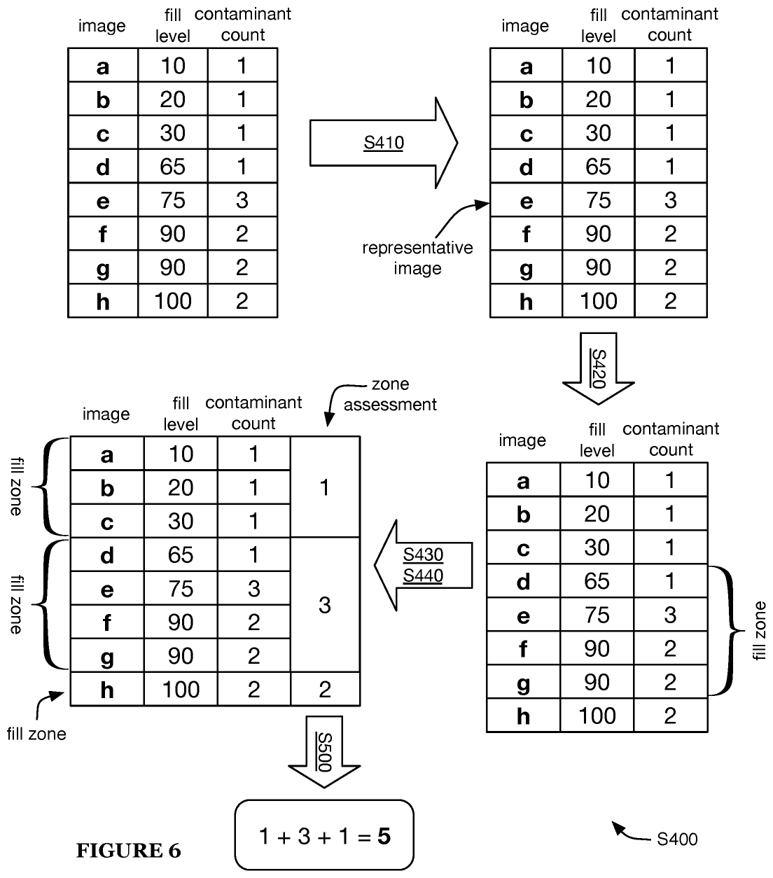

In one variation, the fixed radius is 20%, and a representative image contaminant item count rule is used to assess the fill zones (e.g., wherein the fill zone assessment is equal to the number of contaminants detected in the representative image). In a specific example of this variation (e.g., as shown in FIG. 6), a first representative image, with a fill level of 75% and a contaminant count of 3, is selected; based on this image, a first fill zone (with a fill zone assessment of 3) is defined in the range 55-95%. In this specific example, a second representative image, with a fill level of 100% and a contaminant count of 2, is selected; based on this image, a second fill zone (with a fill zone assessment of 2) is defined in the range 95-100%. In this specific example, a third representative image, with a fill level of 30% and a contaminant count of 1, is selected; based on this image, a third fill zone (with a fill zone assessment of 1) is defined in the range 10-55%.

In some embodiments, S400 includes the following elements (or a subset thereof): for each image of a sorted series (e.g., sorted by fill level, sorted chronologically, etc.) of images (e.g., of the contents of a single container, preferably all sampled by the same camera), determining one or more image contamination metrics (e.g., number of contaminant objects depicted in the image, any other suitable metric such as described above, etc.; a single image contamination metric, a separate metric for each contaminant type, etc.); based on the series order and/or the image contamination metrics, determining a plurality of fill zones (e.g., each corresponding to a contiguous range of fill values), each fill zone associated with a different set of images of the sorted series (e.g., the images with fill values falling within that fill zone's range), preferably wherein the family of sets associated with the fill zones is a partition of the sorted series, wherein the sets are disjoint, and/or wherein the union of the sets consists of every image of the sorted series; and, for each fill zone, based on one or more images of the associated set, preferably based on the representative image (e.g., a representative image selected as described above, selected in any other suitable manner, etc.) but additionally or alternatively based on any other suitable images, determining a fill zone contamination metric (e.g., equal to the representative image contamination metric, determined based on multiple image contamination metrics such as equal to an average or weighted average of multiple image contamination metrics, etc.).

However, S400 can additionally or alternatively include assessing container fill zones in any other suitable manner.

### 3.5 Assessing the Container.

Assessing the container S500 preferably functions to determine an overall contamination assessment of a container (and/or multiple containers, such as a set of containers associated with one or more customers, locations, waste streams, etc.). The contamination assessment is preferably determined based on the fill zone assessments (e.g., determined in S400). In a first example, the overall assessment is equal to the sum of fill zone assessments for the container haul (e.g., if each fill zone assessment is a count of contaminant items). In a second example, the overall assessment is equal to a summary statistic (e.g., mean, median, mode, etc.) of the fill zone assessments (e.g., if each fill zone assessment represents a contamination percentage). The summary statistic is preferably a weighted statistic (e.g., based on the fill zone size, such as the fill level percentage range covered by the zone) such as a weighted average, but can alternatively be unweighted.

S500 can optionally include normalizing the determined value (e.g., count) of the fill zone assessments and/or overall contamination assessment. For example, the contaminant count can be divided by a total assessed volume, such as the maximum haul volume observed (e.g., over the entire course of the haul image set), the haul volume at collection time, the total container volume (e.g., maximum possible content volume), and/or any other suitable volume. However, S500 can additionally or alternatively include assessing the container in any other suitable manner.

S500 can optionally include transforming the determined and/or normalized value into a contamination score (e.g., based on a non-linear scale). For example, a logarithmic scale can be used to generated a contamination score (e.g., wherein a change in the amount of contamination by a factor of 10 can represent a fixed change in the contamination score, such as a 1-point change). However, S500 can additionally or alternatively include determining a contamination score in any other suitable manner.

### 3.6 Acting Based on the Container Assessment.

Acting based on the container assessment S600 can function to utilize the information determined in S500. It can be performed based on the results of S500 (e.g., in response to performing S500), and/or based on any other suitable information.

S600 can optionally include determining user fines and/or charges associated with the container and/or haul based on the contamination assessment (e.g., based on the amount and/or type of contamination). For example, the user may not be charged for any fines (e.g., exceeding a base price associated with container servicing) for a first haul including contamination below a threshold value, but may be charged an excess contaminants fine for a second haul including contamination exceeding the threshold value (e.g., fixed fine; fine based on, such as proportional to, the amount of contamination and/or the contamination score; fine based on, such as proportional to, the amount by which the contamination exceeds the threshold value; etc.).

S600 can additionally or alternatively include determining routing and/or treatment of the container and/or the haul (e.g., the contents of the container for the haul) based on the contamination (e.g., based on the amount and/or type of contamination). For example, the routing and/or treatment can be determined such as described in U.S. patent application Ser. No. 14/479,136, filed 5 Sep. 2014 and titled “System and Method for Waste Management”, which is hereby incorporated in its entirety by this reference. However, S600 can additionally or alternatively include acting in any other suitable manner based on the container assessment.

### 3.7 Training an Image Classifier.

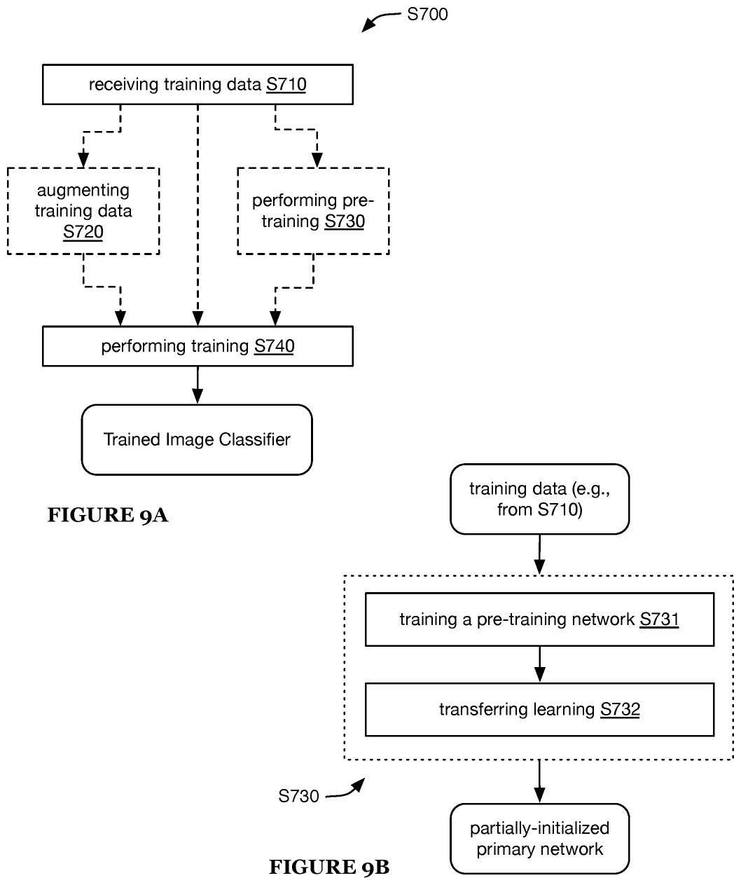

The method 10 can optionally include training an image classifier S700, which can function to train an image classifier (or multiple image classifiers) for use in detecting contaminants. The image classifier is preferably a neural network (e.g., as described above in more detail) such a CNN, but can additionally or alternatively include any other suitable statistical classifiers and/or other classification tools. S700 preferably includes receiving training data S710 and performing training S740, and can optionally include augmenting training data S720 and/or performing pre-training S730 (e.g., as shown in FIGS. 9A-9B). S700 is preferably performed before and/or concurrent with assessing the images (e.g., before using the image classifier to assess the images). S700 is not necessarily performed for each set of images received; rather, once trained, the image classifier can be used for many iterations of the method. In some examples, S700 may be performed again (e.g., after assessing images, after receiving additional information associated with assessed images, etc.) to update the training of the image classifier (e.g., wherein the assessments and/or additional information, or a subset thereof, can be included in the training data) and/or to replace the image classifier with a different classifier. However, S700 can additionally or alternatively include any other suitable elements performed in any suitable manner, and/or with any other suitable timing.

Receiving training data S710 preferably includes receiving a set of labelled images (e.g., images associated with desired classification results). The images are preferably images such as (and/or similar to) those described above regarding S100 (e.g., photos of container interiors), but can additionally or alternatively include any other suitable images. Each image is preferably associated with a set of closed boundaries (e.g., indicating regions of interest, such as bounding a classification object) such as bounding boxes, and one or more classes (e.g., contaminant, specific contaminant type, anomaly, etc.) associated with each boundary. Additionally or alternatively, the image labels can include unclassified boundaries, image-wide contaminant counts (e.g., for each contaminant class, for a single contaminant class, for the sum of all contaminants, etc.), a single image-wide classification (e.g., includes plastic bag(s), includes anomalous item(s), uncontaminanted, etc.), and/or any other suitable label(s). However, S710 can additionally or alternatively include receiving any other suitable training data.

S700 can optionally include augmenting training data S720, which can function to generate additional training data (e.g., labelled images) based on the training data received in S710. S720 can include performing one or more image transformations (e.g., crops, flips, rotations, skews, etc.) to generate additional images (e.g., wherein the associated bounding boxes are modified to follow the relevant regions of interest as they relocate due to such transformations). The transformations preferably function to generate a substantially even distribution of objects of interest (e.g., contaminants) over the set of training data. In some examples, cropping can include cropping toward the lower-center of an image (e.g., as contaminants may be more prevalent in this region, and less prevalent toward the top and/or sides of the received images), but can additionally or alternatively include random cropping and/or cropping toward any other suitable regions of the images. In some examples, flips can include horizontal flips (e.g., corresponding to physically-probably scenes, such as those in which a camera was placed near the adjacent upper corner of the container), but can additionally or alternatively include vertical flips (e.g., which may be less physical) and/or flips about any other suitable line. In some examples, rotations and/or skew transforms can include small-angle operations (e.g., rotating and/or skewing by less than a threshold angle such as 5°, 10°, 15°, etc.), which may correspond to more physical representations, but can additionally or alternatively include larger-angle rotations and/or skew transforms. However, S720 can additionally or alternatively include augmenting the training data in any other suitable manner.

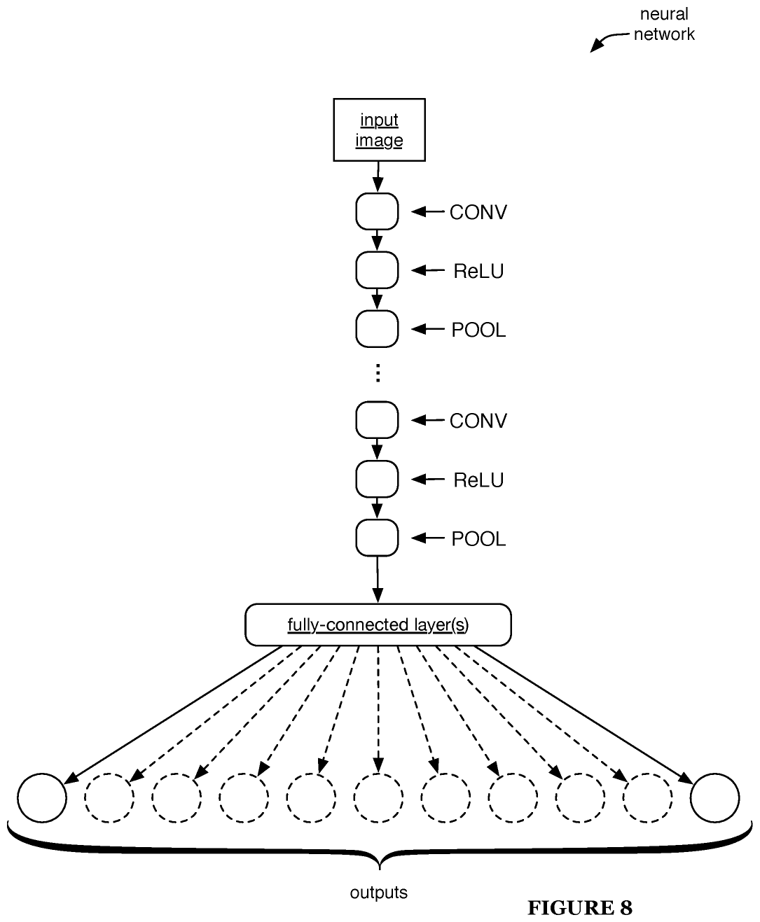

S700 can optionally include performing pre-training S730, which can function to improve training speed and/or resulting performance of the classifier. For example, S730 can include training a pre-training network S731 to perform an associated classification task, and then transferring learning S732 from this pre-training network to a primary network (the image classifier being trained in S700). In this example, the pre-training network preferably includes one or more CONV layers, typically intermixed with (e.g., alternating with) other layers such as POOL and/or ReLU layers, along with a final classification layer (or sub-network), such as shown by way of example in FIG. 8. The pre-training network can accept an input image of a different size than (e.g., smaller than) that accepted by the primary network (e.g., wherein the primary network accepts an image with a lengthscale greater than the pre-training network' input by a factor of 2, 4, 8, 16, etc.), but can additionally or alternatively accept any other suitable input.

S731 preferably includes training the pre-training network based on a derivative of the training data received in S710 (and/or the augmented training data generated in S720). For example, the training can be performed using cropped images from the training data, preferably both images cropped to and/or around a single bounding box (e.g., wherein the image is labelled with the class associated with the bounding box) and images cropped to avoid (e.g., such that they do not include any portions of) the bounding boxes (e.g., wherein the image is labelled as a background image). In this example, the background images will typically depict non-contaminant container contents, empty container interior portions, and background portions in the container environment, whereas the other cropped images will typically depict a single contaminant item or group of items (e.g., among non-contaminant items and/or other background). In this example, the final classification layer preferably functions to classify each input image as either a specific one of the contaminant classes or as a background image (but can additionally or alternatively perform any other suitable classification). However, the pre-training network can additionally or alternatively be trained in any other suitable manner.

S732 preferably includes initializing one or more layers (preferably, CONV layers) of the primary network based on one or more layers (preferably, CONV layers) of the trained pre-training network (e.g., using the same, substantially identical, or otherwise similar coefficients to initialize the primary network layers). This transfer learning can be performed whether or not the pre-training network CONV layers have the same scale as the primary network CONV layers being initialized based on them; rather, only the kernels need have the same size (e.g., wherein identical kernels are used in the associated CONV layers of the pre-training & primary networks). In this example, the remaining layers of the primary network (e.g., CONV layers not initialized based on the pre-training network, non-CONV layers, etc.) are preferably initialized in a typical manner (e.g., randomly), and the remaining layers of the pre-training network (e.g., layers not used to initialize CONV layers of the primary network) are preferably ignored (e.g., not used to affect initialization, training, and/or use of the primary network). However, the transfer learning can additionally or alternatively be achieved in any other suitable manner.

Performing training S740 preferably functions to train the image classifier (e.g., neural network, such as the primary network described above regarding S730). The image classifier is preferably trained using the training data (e.g., training data received in S710 and/or augmented training data generated in S720), but can additionally or alternatively be trained using any other suitable information. In examples in which pre-training is performed, S740 is preferably performed after the pre-training (e.g., after the primary network is initialized based on the pre-training, such as described above regarding S732).

However, S700 can additionally or alternatively include training the image classifier in any other suitable manner.

In embodiments in which multiple different contaminant types are detected, the method and/or a subset thereof (e.g., one or more elements of the method, such as S300, S400, S500, S600, and/or S700) can optionally be performed separately for each contaminant type (and/or set of contaminant types). For example, the method elements (e.g., S300 and S400, and optionally S500, S600, and/or S700) can be performed (e.g., using the images received in S100 and sorted in S200) once for black bags, and a second time for bulky items. This approach can provide more granular data (e.g., providing a separate score associated with each contaminant type) and/or can function to reduce contaminant undercounting (e.g., because each contaminant type is tracked separately). However, the contaminant types can additionally or alternatively be assessed in any other suitable manner, and/or the method 10 can additionally or alternatively include any other suitable elements performed in any suitable manner.

An alternative embodiment preferably implements the some or all of above methods in a computer-readable medium storing computer-readable instructions. The instructions are preferably executed by computer-executable components preferably integrated with a communication routing system. The communication routing system may include a communication system, routing system and a pricing system. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Although omitted for conciseness, embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

The FIGURES illustrate the architecture, functionality and operation of possible implementations of systems, methods and computer program products according to preferred embodiments, example configurations, and variations thereof. In this regard, each block in the flowchart or block diagrams may represent a module, segment, step, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

We claim:

1. A method for contamination assessment, comprising:
receiving a set of images of an interior of a container, each image of the set of images associated with a respective fill metric, wherein the set of images defines an overall fill range between a minimum fill metric of the set and a maximum fill metric of the set;
training a neural network, configured to accept an input image, to detect contaminants depicted in the input image;
using the neural network, for each image of the set of images, determining a respective contamination metric associated with the image;
based on the set of images, iteratively determining a set of fill ranges, wherein iteratively determining the set of fill ranges comprises:
a) selecting a representative image from an unassigned images subset of the set of images;
b) determining a respective fill range around the representative image, wherein the respective fill range is associated with the representative image;
c) adding the respective fill range to the set of fill ranges;
d) updating the unassigned images subset, comprising, for each image of the unassigned images subset for which the respective fill metric of the image is within the respective fill range, removing the image from the unassigned images subset; and
e) repeating elements a, b, c, and d until the unassigned images subset is empty;
for each fill range of the set of fill ranges, based on the respective contamination metric of the associated representative image, determining a respective fill range contamination metric; and
based on the respective fill range contamination metric of each fill range of the set of fill ranges, determining a container contamination metric.

2. The method of claim 1, further comprising, for each image of the set of images, determining the respective fill metric.

3. The method of claim 2, wherein determining the respective fill metric comprises, based on the image, estimating a volumetric fill fraction of the container.

4. The method of claim 2, wherein each image of the set of images is further associated with a respective auxiliary measurement sampled substantially concurrently with the image, wherein determining the respective fill metric is performed based on the respective auxiliary measurement.

5. The method of claim 4, wherein each respective auxiliary measurement is a container weight measurement.

6. The method of claim 1, further comprising, for each image of the set of images, determining the respective contamination metric.

7. The method of claim 1, wherein the neural network is configured to determine a number of contaminant objects of a contaminant type depicted in the input image, wherein, for each image of the set of images, determining the respective contamination metric comprises, using the neural network, determining a respective number of contaminant objects of the contaminant type depicted in the image.

8. The method of claim 7, wherein the neural network is configured to determine a number of black bags depicted in the input image.

9. The method of claim 1, wherein, for each fill range of the set of fill ranges, the respective fill range contamination metric is equal to the respective contamination metric of the associated representative image.

10. The method of claim 1, wherein determining the respective fill range contamination metric is performed based further on the respective contamination metric of a second image, wherein the respective fill metric of the second image is within the respective fill range.

11. The method of claim 1, wherein determining the container contamination metric comprises determining a sum of the respective fill range contamination metric of each fill range of the set of fill ranges.

12. The method of claim 1, further comprising determining the unassigned images subset, comprising selecting substantially non-duplicative images from the set of images.

13. The method of claim 1, wherein selecting the representative image comprises selecting a highest contamination image from the unassigned images subset as the representative image, wherein the respective contamination metric of the highest contamination image is greater than or equal to the respective contamination metric of each image of the unassigned images subset.

14. The method of claim 13, wherein selecting the representative image further comprises:
determining a plurality of candidate images of the unassigned images subset, wherein each candidate image of the plurality has a respective contamination metric greater than or equal to the respective contamination metric of each image of the unassigned images subset;
determining an unassigned fill range, bounded by a first fill range and a second fill range of the set of fill ranges; and
selecting the highest contamination image from the plurality of candidate images based on a midpoint fill value of the unassigned fill range, wherein the respective fill metric of the highest contamination image is closer to the midpoint fill value than the respective fill metric of any other candidate image of the plurality.

15. The method of claim 1, wherein, the fill ranges of the set of fill ranges are disjoint.

16. The method of claim 1, wherein, for each fill range of the set of fill ranges, determining the fill range around the representative image is performed based on a threshold fill range radius.

17. The method of claim 16, wherein:
the threshold fill range radius is between 5% and 35% of a maximum fill of the container;
a minimum fill value of the fill range is substantially equal to the greatest of:
the respective fill metric of the representative image minus the threshold fill range radius; and
a respective maximum fill value of each previously-determined fill range of the set of fill ranges for which the respective fill metric of the representative image is above the previously-determined fill range; and
a maximum fill value of the fill range is substantially equal to the least of:
the respective fill metric of the representative image plus the threshold fill range radius; and
a respective minimum fill value of each previously-determined fill range of the set of fill ranges for which the respective fill metric of the representative image is below the previously-determined fill range.

18. The method of claim 1, wherein training the neural network comprises:
receiving a set of training data, each element of the training data comprising:
a respective training image; and
contaminant information associated with the respective training image; and
training the neural network based on the set of training data, comprising:
for each element of the set of training data:
providing the respective training image to the neural network as input; and
evaluating a loss function based on a comparison of the contaminant information with a neural network output; and
based on the evaluations of the loss function, modifying the neural network.

19. The method of claim 18, further comprising generating a set of augmented training data based on the set of training data, comprising:
selecting a subset of training images from the set of training data;
for each training image of the subset:
generating a respective set of augmented images, comprising, for each augmented image of the respective set, performing a respective transform on the training image, wherein the transform comprises at least one of a cropping operation, a flipping operation, or a rotation operation;
for each augmented image of the respective set, based on the respective transform and the contaminant information associated with the training image, determining contaminant information associated with the augmented image, wherein the augmented image and the associated contaminant information are associated with a respective element of the set of augmented training data; and
before training the neural network based on the set of training data, adding the set of augmented training data to the set of training data.

20. The method of claim 18, wherein the neural network comprises a first set of convolutional layers, wherein training the neural network further comprises:
based on the set of training data, generating a set of pre-training data;
training a pre-training network based on the pre-training data, wherein the pre-training network comprises a second set of convolutional layers; and
after training the pre-training network and before training the neural network based on the set of training data, initializing the first set of convolutional layers based on the second set of convolutional layers.
